(19) United States
(12) Patent Application Publication
(10) Pub. No.: US 2010/0159872 A1
(43) Pub. Date: Jun. 24, 2010

(54) MOBILE DEVICE WEBSITE VISITOR METRIC SYSTEM AND METHOD

(75) Inventors: Blandon Cephas Casenave, Bronx, NY (US); Rohun Vijay Gholkar, New York, NY (US); Christopher Johannessen, Allentown, PA (US)

Correspondence Address: Patrick S. Yoder, P.O. Box 692289, Houston, TX, 77269-2289, US

(73) Assignee: NBC Universal, Inc., New York, NY (US)

(21) Appl. No.: 12/340,178

(22) Filed: Dec. 19, 2008

(51) Int. Cl. H04W 4/00

(52) U.S. Cl. 455/405

(57) ABSTRACT

Visits to a website or the like by mobile devices may be logged and counted based upon a subscriber ID or a session ID. If content is accessed via a carrier site, and a subscriber ID is available for the mobile device, the subscriber ID is used to record and count the visit. If the subscriber ID is not available, the session ID is used to record and count the visit. The session ID is attributed to a session that is initiated when content is accessed by the mobile device from the site. The session continues until the mobile device leaves the site. A cookie may also be set with the mobile device, if possible, and used in lieu of the subscriber and session IDs. More accurate measurements of site visits and visitors via mobile devices are afforded.

### BACKGROUND OF THE INVENTION

The present invention relates generally to providing digital content to mobile devices. The invention particularly relates to techniques for evaluating a number of visits or devices that visit sites and that download content.

Digital content is currently provided in several different ways and through several different channels to users. Most of these channels involve some use of the Internet. Although some content may be accessed through specific service providers, these generally also use the Internet for the delivery of content. Regardless of the nature of the content or how it is delivered, it is often useful to maintain some measurement of the number of times content is accessed, and the number of users or visitors to certain sites. For stationary systems, such as desktop computers, identifying code, commonly referred to as “cookies” may be loaded onto the user's computer by certain providers or sites. These cookies may then be used to identify when and how the same computer accesses the same or other content. These cookies may be used in conjunction with Internet protocol (IP) addresses to track content access and website visits.

The use of such cookies and IP addresses, however, is problematic for mobile devices, such as cellular telephones, personal digital assistants, and similar devices. In particular, such devices may not be capable of downloading cookies. Similarly, IP addresses do not necessarily operate in the same way on mobile devices. Such constraints make measuring and accounting for visits to certain sites and access to content difficult or even impossible.

Measuring of and accounting for visits and visitors to certain sites is important in many contexts, particularly where advertising is provided based upon the number of visits or the number of visitors that access content. For example, banner ads may be provided on certain sites, and accounting for the placement of the ads may be based upon a count of the number of visits or the number of different visitors to one or more website pages. The inability to account for visits by mobile devices may deflate the traffic metric used for such accounting. Analytics tools have been developed in an attempt to accurately account for such mobile device traffic, but these may, conversely, inflate the traffic metric. In both cases, the inaccuracy is problematic, particularly insomuch as no reliable accounting can be made. These problems are exacerbated by a rapid and continuous increase in the number of mobile devices capable of accessing web-based content.

There is a need, therefore, for improved techniques for measuring and accounting for website visits. The need is particularly acute insomuch as it relates to tracking mobile device access to digital content.

### BRIEF DESCRIPTION OF THE INVENTION

The invention provides a novel technique for measuring and accounting for web site visits and access to web content designed to respond to such needs. In accordance with the technique, a method is provided for measuring digital content access. In the method, a count is augmented based upon subscriber identification data when the digital content is transmitted to a mobile device and the subscriber identification data is available. The count is augmented based upon session identification data when the digital content is transmitted to the mobile device and the subscriber identification data is not available.

In accordance with one implementation of the method, digital content is transmitted to a mobile device from one of a carrier and a non-carrier. A session is initiated and session identification data is attributed to the session when the digital content is provided by the non-carrier. The count is then augmented based upon subscriber identification data when the subscriber identification data is available. The count is augmented based upon the session identification data when subscriber identification data is not available.

A system is also provided for measuring digital content access. The system includes a server for transmitting digital content to a mobile device from one of a carrier and a non-carrier. Session identification data is attributed to a session when the digital content is provided by the non-carrier. A count is augmented based upon subscriber identification data when the subscriber identification data is available, and that is augmented based upon the session identification data when subscriber identification data is not available.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a digital content delivery system for providing digital content to a mobile device and for accounting for visits by the mobile device to websites;

FIG. 2 is a flow diagram illustrating exemplary logic for delivering digital content to mobile devices from two possible sources, a carrier site and a non-carrier site;

FIG. 3 is a flow chart illustrating exemplary logic for accounting for the delivery of digital content by reference to subscriber identification data and session identification data;

FIG. 4 is a diagrammatical overview of an alternative embodiment of a digital content delivery system in which one of several bases may be used for accounting for visits by a mobile device to websites; and

FIG. 5 is a flow diagram illustrating exemplary logic for the system of FIG. 4.

### DETAILED DESCRIPTION OF THE INVENTION

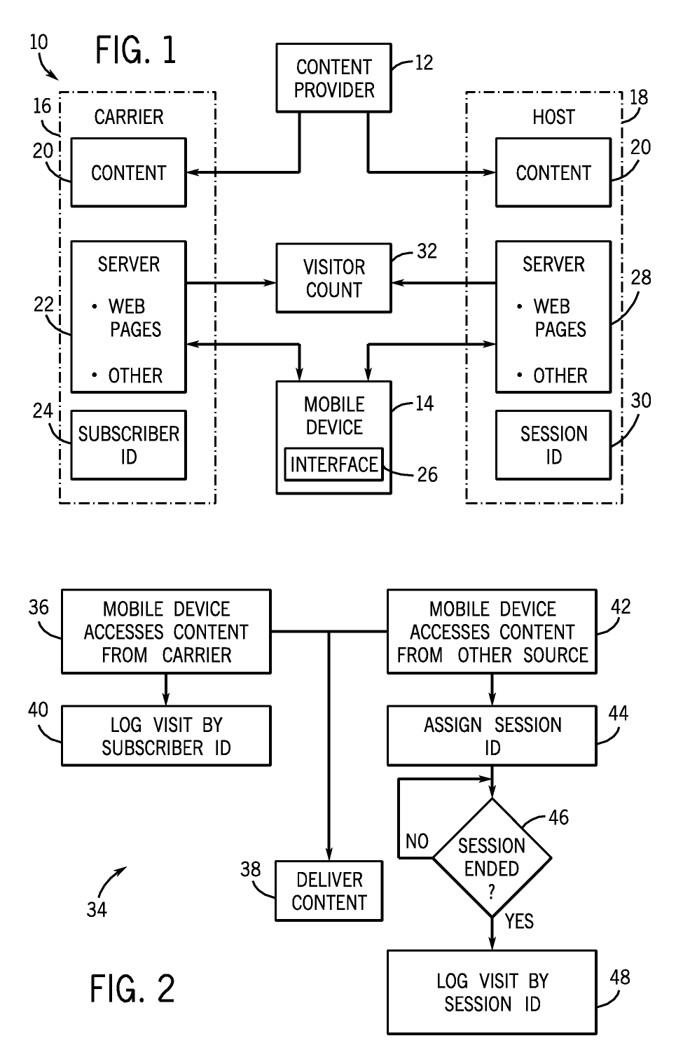

Turning now to the drawings, and referring first to FIG. 1, a digital content delivery system 10 is illustrated generally and includes a content provider 12 that formulates and creates content that is ultimately provided to a mobile device 14. The content provider 12 may be any suitable content provider, such as website creators, movie studios, television content creators, document creators, and so forth. The mobile device 14, on the other hand, may include any device that is not permanently in network contact with a service provider in a stationary location, and for which cookies and IP address data is insufficient or unreliable for tracking and counting visits to sites. In general, the mobile devices will include cellular telephones, personal digital assistants, and so forth that are not wired to an Internet service provider and that do not access content via a local area network or similar arrangement. The mobile device will typically access the content via a carrier that provides the content in specially-designed interface screens, or similarly through websites that can be accessed via cellular networks, edge networks, and so forth over the airwaves.

As illustrated in FIG. 1, a carrier 16 that is typically in a contractual relationship with the owner of the mobile device 14 may provide content from the content provider. Similarly, any other host, indicated generally by reference numeral 18, that is not the carrier may also provide content, through similar airwave channels. For delivery of the content, the content provider 12 will typically make content available through the carrier or the host, as indicated by reference numeral 20. This content may include web pages, documents, audio files, video files, multi-media files, and so forth that can be brought up on the mobile device once transferred, viewed or listened to, or both, and in some cases stored on the mobile device.

In certain contexts, the carrier will provide specific carrier sites through which the content is offered, the site constituting the delivery mechanism for the content. Such content delivery channels are sometimes referred to as “on-deck”. Content that is not provided by a carrier on a carrier site is sometimes referred to as “off-deck”. Depending upon contractual arrangements between the content provider, the host, the carrier and any other parties involved, advertisers may contract to add banner ads and other visual or audio advertising content to the web pages. The present technique allows for tracking and accounting for visits to sites by the mobile devices and access to content by the mobile devices such that such advertisers may be accorded accurate numbers of visits and visitors for accounting purposes under such contracts.

As further illustrated in FIG. 1, on the carrier side site, the carrier will employ one or more servers 22 which will be capable of serving web pages and other data to the mobile device. Because the mobile device maintains a relationship, typically a contractual relationship, with the carrier, the carrier is capable of providing subscriber identification (ID) data 24 corresponding to the mobile device when the mobile device accesses content from the server. For access of the data, then, the mobile devices, via an interface 26, will access or “hit” the carrier site and access one or more screens or pages (or other content) from the server 22. Depending upon the mobile device 14, the interface 26 may include a browser or similar interface through which the user can navigate to the address of the carrier site to access the content. This is typically done by sending an address corresponding to a default to the carrier site, or through use of a conventional uniform resource locator (URL). The subscriber ID 24 may also be used to track which mobile device receives which content from the server 22. The ability to use a subscriber ID code will typically depend upon the carrier that a subscriber employs, the browser or interface used, and so forth. For example, the browser may use and Internet proxy or a carrier gateway. In some cases, the proxy will not add the subscriber ID, while the gateway may do so.

Similarly, the mobile device may access content from the host 18. In this case, the host 18 will also employ one or more servers 28 which may provide web pages and other data. The content will be provided via the web pages, and may be linked to the web pages, as in the case of content provided by the carrier, such as in the case of audio, video and multi-media files. In accordance with the present techniques, a session ID code 30 may be initiated when the mobile device access particular websites from the host. For the user, the experience is quite similar, however, with the content being downloaded to the mobile device for viewing, listening, and so forth.

To account for the access to the content and the downloading of content by the mobile device, to separate techniques are envisaged that work in unison. If the mobile device 14 accesses content from the carrier 16, and the subscriber ID 24 is available, a visitor count 32 is logged based upon the subscriber ID. If, on the other hand, no such subscriber ID is available, particularly when content is accessed from a non-carrier host, the session ID 30 initiated when the content is accessed (typically when a website is “hit” is used to augment the visitor count 32). The visitor count 32 may be maintained by a third party which is contracted by the host, the carrier, the content provider or any of these together, to track the number of times content is accessed and provided to mobile devices. Although not shown in FIG. 1, many hundreds and thousands, or even millions of mobile devices 14 may access the content, and the use of the subscriber IDs and session IDs may be used to maintain an accurate count of visitors that access specific content.

In a presently contemplated embodiment, a session ID may consist of a random string of data that is attributed or created when a site is first contacted by a mobile device. This may occur when the device access the site by reference to a specific URL, for example. The session, then, may end when the mobile device exits the site. Depending upon the strategies employed for tracking a URL parameter may be employed to detect that a user of the mobile device has not actually left the site but has accessed other pages within the same site. Thus, accessing previous pages or backing out of pages and into previously viewed pages or files may not be separately counted. Because the session ID is created on the server side of the delivery system, no specific data necessarily needs to be delivered to the mobile device, other than the content requested. In a presently contemplated embodiment, multiple page counts (corresponding to access to multiple viewable screens at a site) may all be part of the same session, thus avoiding overly inflating the visit count. In certain contexts, it may be desired that the visitor count 32 reflect, in fact, an “impression” which generally corresponds to an individual viewing event of a site or content by a mobile device. The visitor count 32 may then be used in various analytics tools to determine not only the number of visitors and mobile devices that accessed a site, but when sites were accessed, where sites were accessed, and in certain situations progression of access through various pages and sites, as well as, to some degree, demographics related to the mobile device.

FIG. 2 represents exemplary logic for providing digital content to the mobile device from either a carrier or similar source, or from a non-carrier host. The logic, designated generally by reference numeral 34, includes accessing of the content by the mobile device from the carrier, as represented by block 36. As mentioned above, this may be done by directing a request from the mobile device to a website of the carrier, or by dialing or otherwise specifying a default site for the carrier. If the mobile device is contracted with the carrier, such defaults may be pre-programmed into the device and easily accessed, such as by touching a key or location on the device. The content is then delivered by the carrier server as described above, and as represented by block 38. The visit or “hit” to the site by the device is then logged based upon the subscriber ID, as indicated by block 40. As will be appreciated by those skilled in the art, this logic may be carried out on the carrier server, but may also involve an outside or third party computer, such as for an analytics firm contracted to track and measure visits to the site or access to specific pages or content (e.g., for the purposes of estimating advertising proceeds). As noted above, the content may include various information and advertising that may be contracted for by the carrier, the content provider, or both.

The mobile device may also access the content from sources other than the carrier, as indicated at step 42. In this case, no subscriber ID will be available for logging the visit and content access. This may also be the case when an IP address or browser (or other interface software) on the mobile device makes reference to a subscriber ID impossible. Upon receipt of the request for the content, it is again delivered to the mobile device, as indicated by block 38. Upon initiation of the visit to the site, however, a “session” is initiated by assignment of a session ID to the mobile device. As noted above, the session ID may be a set of bits that will be used to track and note the visit by the device to the site, and may not change so long as the session continues. In accordance with a presently contemplated embodiment, a session continues until the site is left by the user of the mobile device. It may also be possible avoid attributing a new session ID to the mobile device for a set time after the site has been left, so as to avoid counting the mobile device again if the site is reaccessed by the mobile device shortly after being left. As indicated by block 46, so long as the session does not end, the session ID remains in effect. Once the session ends, however, the visit is logged by reference to the session ID, as indicated by step 48. Again, this logic may be performed by the host, but will typically also involve some processing by a third party, if one is employed for measuring visits to the site.

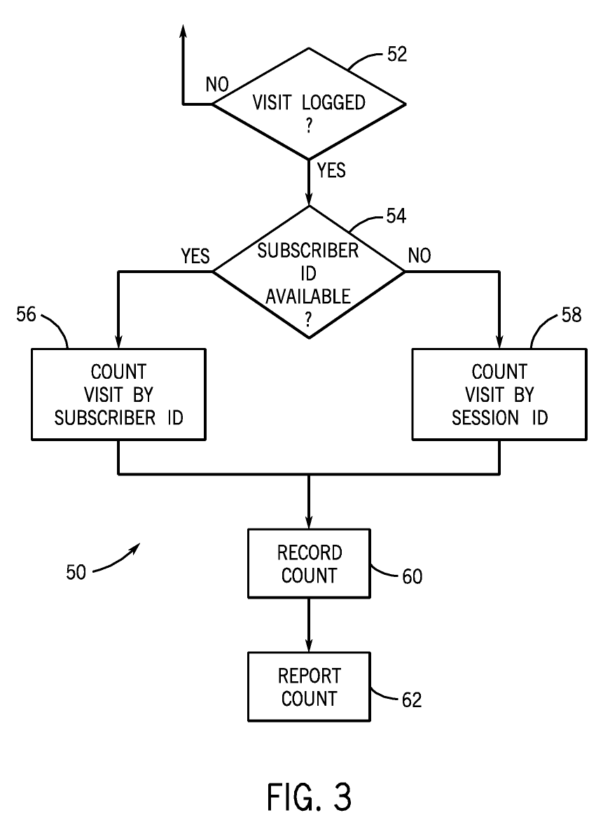

FIG. 3 illustrates exemplary logic for counting visits by mobile devices based upon such logging. The logic, represented generally by reference numeral 50, begins by determining that a visit has been logged, as indicated at block 52. One a visit has been logged, the logic determines whether a subscriber ID is available. As noted above, this will typically be the case if the mobile device accessed the content through the carrier site. If a subscriber ID is available, a count is augmented by reference to the subscriber ID, as noted at block 56. The count may be made by recording on a running list the subscriber ID, and any other relevant information that is available, such as the pages accessed, content downloaded, advertisements viewed, and so forth.

If at step 54 no subscriber ID is available, the logic augments the count based on the session ID, as indicated by block 58. Again, where a list is maintained of the relevant data available about the visit, the visit or visitor may be designated by this session ID. In either case, the visit represents an “impression” for accounting purposes.

Once the count has been augmented, the counts are recorded, as indicated generally by block 60. Such recording may include recordal of relevant data on a listing, as indicated above. The recordal will also typically include storing the visit-related data in a memory device (not shown), such as at the carrier, the host, the content provider, or a third party tasked with measuring and counting visits or visitors (or more generally, “impressions”). As indicated by step 52, the count will then be reported, such as by the third party to the carrier, the host, the content provider, advertisers, and so forth. The report may serve as the basis for compensation by advertisers to one of more of the carrier, the host, and the content provider.

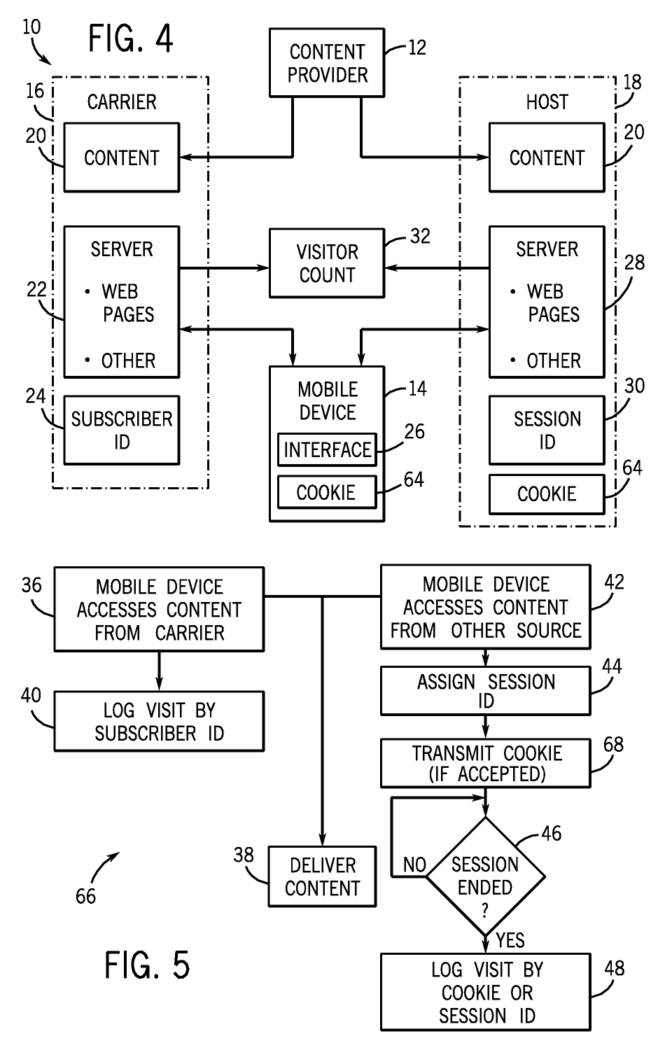

In an alternative approach, counts of visits by mobile devices may be made by reference to cookies, subscriber ID, or session ID, depending upon logic similar to that described above. FIG. 4 illustrates a system similar to that discussed with respect to FIG. 1, but wherein the host 18 is configured to deliver a cookie 64 to the mobile device 14. As will be appreciated by those skilled in the art, as used herein, the term “cookie” refers to a parcel of text or data sent by a server or other computer, such as the host in this case, and which may then be sent back by the accessing mobile device each time that it accesses that server or computer. The cookie may be in conformance with the hypertext transfer protocol (HTTP), or any other protocol or standard. Thus, in the embodiment illustrated in FIG. 4, the host not only originates session ID as indicated by reference numeral 30, but may set cookies as indicated by reference numeral 64. If the mobile device 14 is capable of receiving, storing and retransmitting such data, then, the cookie may be a preferable device for accurately monitoring visits to the host or to web pages provided by the host to the mobile device. It should also be noted that such cookies may also be set by the carrier, if desired.

FIG. 5 illustrates a flow of exemplary logic similar to that summarized in FIG. 2 above, but wherein the scheme may include monitoring of cookies instead of or in addition to the other identification devices discussed above. The process is essentially identical to that summarized in FIG. 2, but the modified process, indicated generally by reference numeral 66, includes the transmission of a cookie at step 68. As will be appreciated by those skilled in the art, not all mobile devices will be capable of handling such cookies and, if not, the cookie may not be satisfactorily transmitted and handled by the mobile device (thus, the transmission cookie step 68 in FIG. 5 carries the proviso “if accepted”). As further indicated in FIG. 5, if the cookie can be handled by the mobile device, the visit may be logged by the cookie or by the session ID as indicated at step 48.

In one presently contemplated embodiment, all three of the devices described above, including cookies, subscriber ID's and session ID's may be used for tracking visits by particular visitors to websites and the downloading of content by the visitor via a mobile device. In this presently contemplated embodiment, if a subscriber ID is available, as described above, this subscriber ID is preferred. If no subscriber ID is available, but a cookie is available, this cookie is used for visit tracking and accounting. If neither of the subscriber ID nor a cookie is available, the session ID is once again used. As in the previous embodiment, all of these devices will contribute to a single count of visits and/or visitors who access particular content.

Technical effects of the invention include the ability to detect, log, track, and count visits or visitors to sites via mobile devices. The use of subscriber ID's and session ID's, in particular, allows for specific tracking of usage by subscribers when such information is available (via the subscriber ID's), and counting of visits to sites when such detailed information is not available (via the session ID's). The invention, then, offers the potential to more accurately measure site visits without over or underestimating traffic.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for measuring digital content access comprising:
augmenting a count based upon subscriber identification data when the digital content is transmitted to a mobile device and the subscriber identification data is available; and
augmenting the count based upon session identification data when the digital content is transmitted to the mobile device and the subscriber identification data is not available.

2. The method of claim 1, comprising setting a cookie with the mobile device and augmenting the count based on the cookie in lieu of either the subscriber identification data, the session identification data or both.

3. The method of claim 1, comprising initiating a session corresponding to the session identification data when the mobile device accesses the digital content.

4. The method of claim 4, comprising initiating a session identification only when the mobile device accesses the digital content from a content site other than a site for a subscription service provider for the mobile device.

5. The method of claim 4, wherein the session is initiated when the mobile device accesses a particular site.

6. The method of claim 5, wherein the session is terminated when the mobile device leaves the particular site.

7. The method of claim 1, comprising transmitting the digital content to the mobile device.

8. The method of claim 1, wherein the digital data includes a video file, an audio file, or a multi-media file.

9. The method of claim 1, comprising storing and reporting the count to the content provider.

10. The method of claim 1, wherein the digital content includes advertising data.

11. A method for measuring digital content access comprising:
augmenting a count based upon a cookie set with a mobile device when the digital data is transmitted to the mobile device and the cookie can be handled by the mobile device;
augmenting the count based upon subscriber identification data when the digital content is transmitted to a mobile device and the subscriber identification data is available but the cookie cannot be handled by the mobile device; and
augmenting the count based upon session identification data when the digital content is transmitted to the mobile device and the cookie cannot be handled by the mobile device and the subscriber identification data is not available.

12. A method for measuring digital content access comprising:
transmitting digital content to a mobile device from one of a carrier and a non-carrier;
initiating a session and attributing session identification data to the session when the digital content is provided by the non-carrier;
augmenting a count based upon subscriber identification data when the subscriber identification data is available; and
augmenting the count based upon the session identification data when subscriber identification data is not available.

13. The method of claim 12, comprising setting a cookie with the mobile device and augmenting the count based on the cookie in lieu of either the subscriber identification data, the session identification data or both.

14. The method of claim 11, wherein the session is initiated when the mobile device accesses a particular site.

15. The method of claim 11, wherein the session is terminated when the mobile device leaves the particular site.

16. The method of claim 11, wherein the digital content includes a video file, an audio file, or a multi-media file.

17. The method of claim 11, comprising storing and reporting the count to the content provider.

18. The method of claim 11, wherein the digital content includes advertising data.

19. A system for measuring digital content access comprising:
a server for transmitting digital content to a mobile device from one of a carrier and a non-carrier;
session identification data attributed to a session when the digital content is provided by the non-carrier;
a count that is augmented based upon subscriber identification data when the subscriber identification data is available, and that is augmented based upon the session identification data when subscriber identification data is not available.

20. The system of claim 19, comprising a carrier server configured to transmit the digital content from the carrier, and a non-carrier server configured to transmit the digital content from the non-carrier.

22. The system of claim 19, wherein the session identification data is attributed to the session upon access to the digital content by the mobile device.

23. The system of claim 19, wherein the count is maintained by a third party apart from the carrier and the non-carrier.

24. The system of claim 19, comprising a count record including data representative of a number of visits to a site, content accessed, and advertisements viewed.
